(19) United States
(12) Patent Application Publication
(10) Pub. No.: US 2014/0080557 A1
(43) Pub. Date: Mar. 20, 2014

(54) RHYTHM GAME APPARATUS, GAME METHOD, AND RECORDING MEDIUM

(71) Applicant: Minhwan O, Seoul (KR)

(72) Inventor: Minhwan O, Seoul (KR)

(73) Assignee: NEOWIZ GAMES CORPORATION, Seongnam-si, Gyeonggi-do (KR)

(21) Appl. No.: 14/122,515

(22) PCT Filed: Sep. 27, 2011
(86) PCT No.: PCT/KR2011/007075

§ 371 Date: Nov. 26, 2013

(30) Foreign Application Priority Data
Jul. 20, 2011 (KR) 10 2011 0072147

(51) Int. Cl. G06Q 30/06

(52) U.S. Cl. CPC G06Q 30/0601
USPC 463/7

(57) ABSTRACT

Disclosed are a game apparatus, a game method, and a record medium, which allow a user to purchase a music file and game data used for a rhythm game only once so that purchase costs of the music file and the game data are reduced and the user can enjoy the rhythm game at a low cost.

### TECHNICAL FIELD

The present invention relates to a game technology, and more particularly to a game apparatus, a game method, and a recording medium, which enables a user to purchase a single use game package including a music file and game data, so that the user can enjoy a rhythm game at low costs.

### BACKGROUND ART

In a conventional rhythm game, it is common to collectively purchase rhythm game software including a plurality of music files, or separately purchase a music file after purchasing the rhythm game software in order to execute the rhythm game. However, when a music file is included in the rhythm game software, there is a problem in that a user cannot help purchasing an unwanted music file since the user has no right to select the music file. Further, when the user separately purchases a music file, the user should pay for the music file itself regardless of how many times the music file is used.

### DISCLOSURE OF INVENTION

### Solution to Problem

Accordingly, the present invention has been made to solve the above-mentioned problems occurring in the prior art, and an aspect of the present invention enables a user to separately purchase a music file from game software, and purchasing costs of the music file to be reduced by allowing the music file to be purchased according to the number of uses of the music file.

In order to accomplish this object, there is provided a game apparatus including: a download unit for, when a music file is selected from a sound source list including one or more music files in performing a rhythm game, in which game data displayed in a game screen is changed according to the music file, accessing an outside game server to download a game package including the music file and the game data matched to the music file; and a game controller for controlling a reproduction number of the music file and the game data downloaded from the game server according to a purchase payment type of the game package.

In accordance with another aspect of the present invention, there is provided a game system including: a game DB for storing a game package, to which one or more music files used for a rhythm game, in which game data displayed in a game screen is changed according to the music file, and the game data, which is designed according to each of the music files, are matched; game apparatus for downloading the game package stored in the game DB and executing the music file and the game data interworked with each other; and a game server for controlling a reproduction number of the music file and the game data according to a purchase payment type of the game package.

In accordance with another aspect of the present invention, there is provided a game method including: displaying a sound source list including one or more music files required for performing a rhythm game, in which game data displayed in a game screen is changed according to the music file; downloading, when a particular music file is selected from the music files in the sound source list, a game package including the music file together with the game data matched to the music file; executing the music file and the game data interworked with each other; and determining whether the music file and the game data will be executed again according to a purchase payment type of the music file and the game data.

In accordance with another aspect of the present invention, there is provided a computer readable recording medium recording a program for implementing a game method, the program implementing functions of: downloading, when a music file is selected from a sound source list including one or more music files in performing a rhythm game, in which game data displayed in a game screen is changed according to the music file, a game package including the music file and the game data matched to the music file from an outside game server; reproducing the music file and the game data interworked with each other; and limiting a reproduction number of the music file and the game data according to a purchase payment type of the game package.

In accordance with another aspect of the present invention, there is provided a game system including: a game apparatus including a game screen divided into a plurality of track regions; a game DB in which a plurality of game data constructed by selecting a note type of notes moving in the track regions; and a game server providing the game data stored in the game DB to the game apparatus.

According to the present invention, the single use game package including both the music file and the game data is allowed to be purchased, so that it is possible to markedly reduce purchase costs of the music file and the game data.

### BRIEF DESCRIPTION OF DRAWINGS

The above and other objects, features and advantages of the present invention will be more apparent from the following detailed description taken in conjunction with the accompanying drawings, in which:

FIG. 1 is a diagram schematically illustrating a rhythm game system according to the present invention;

FIG. 2 is a block diagram of a game apparatus according to the present invention;

FIG. 3 illustrates a screen displaying a sound source list;

FIG. 4 illustrates a download screen through which a music file is downloaded;

FIG. 5 illustrates a preview play screen;

FIG. 6 illustrates a screen displaying a game result;

FIG. 7 illustrates a main menu screen;

FIG. 8 illustrates a music point payment screen;

FIG. 9 is a relationship diagram illustrating encryption and decryption processes between a game apparatus and a game server; and

FIG. 10 is a flowchart illustrating a process of executing a rhythm game in a rhythm game system of FIG. 1.

### MODE FOR THE INVENTION

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

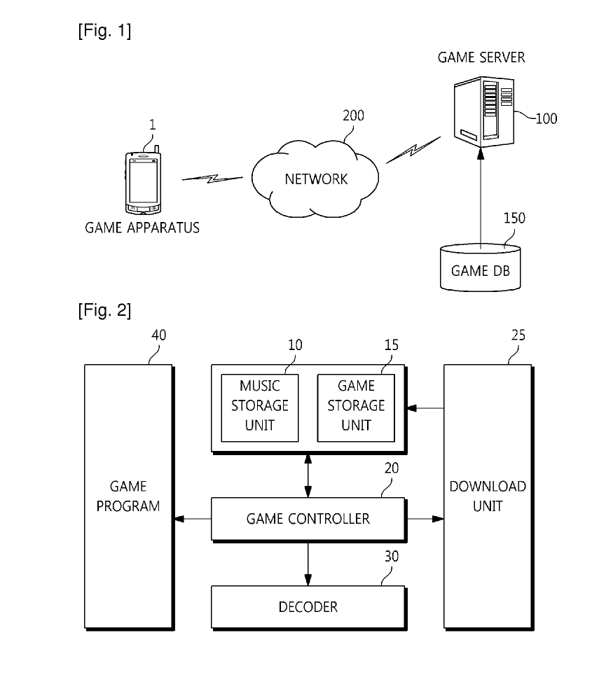

FIG. 1 is a diagram schematically illustrating a rhythm game system according to the present invention.

According to an embodiment of the present invention, a game provided by a game apparatus shown in FIG. 1 is a game having a play scheme where a user inputs by touching a particular place of a touch screen according to an input timing (control timing) and/or an input position indicated by a component displayed in a game screen of the touch screen and the user identifies a determination result according to the input.

Further, such a game is a game having a play scheme similar as a scheme where a user plays or directs music since a part of components displayed in the game screen is changed according to a flow of music while the music is played. The game is referred to as a music game, a rhythm game, a performance game, or a direction game, and the term rhythm game is used to refer to the game in a detailed description of the present invention.

In general, a game program 40 supporting a game execution is installed in a game apparatus 1. There is a case where the game program 40 includes game contents to enable the game to be directly executed in the game apparatus 1, or a case where the game contents required for the game should be downloaded in every game execution. Hereinafter, in detailed embodiments of the present invention, a case where the game program 40 is installed in the game apparatus 1 for the rhythm game and at least one of a music file and game data, which are the game contents, is downloaded in every game execution will be described as an example.

According to the present invention, at least one game data is generated for each music file, and the game data is generated such that notes displayed in a game screen are matched to a rhythm of the music. Generally, in the rhythm game, the game screen is divided into a plurality of track regions, a determination region indicator for determining the accuracy of an input timing and an input position is displayed on one side of the track, and the note including a head and a tail is displayed while moving toward the determination region indicator.

The note basically includes the head, which is an input start indication part for indicating a start of the touch input, and the tail, which is an input continuance indication part for indicating how long the touch input should be consistently maintained. The head and the tail may have various shapes, colors, sizes, etc.

That is, in the game data, a type of the note (a note type) moving in the plurality of track regions, a shape, a color, a displayed pattern on the game screen, a movement pattern (a speed, a movement route, etc.) on the game screen, etc. may be variously designed according to the rhythm of the music.

According to the present invention, the game system includes the game apparatus 1 for being provided with game data and music to execute them, a game server 100 for controlling the provision of the game data and the music file executed in the game apparatus 1, a game DB 150 storing the game data displayed on the game screen and the music file interworked with the rhythm game as shown in FIG. 1.

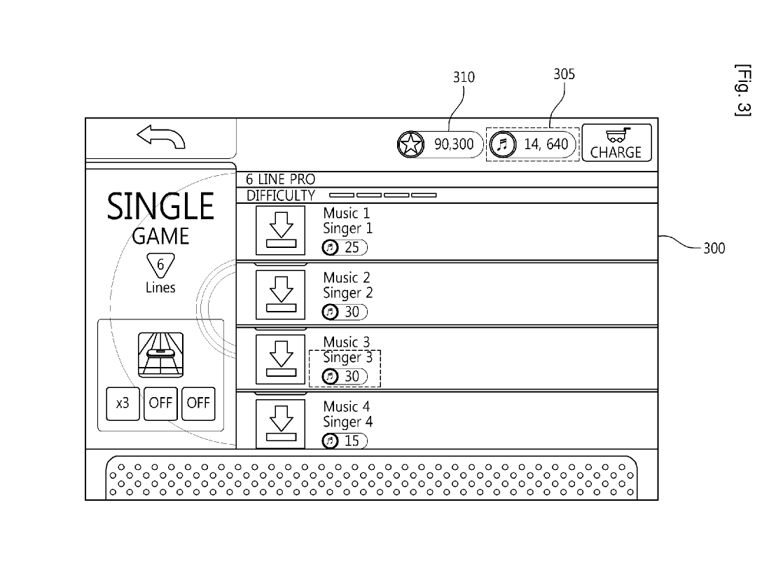

FIG. 2 is a block diagram of the game apparatus according to the present invention.

The game apparatus 1 according to the embodiment of the present invention downloads the music file and the game data stored in the game DB 150, makes the music file interworked with the game data and executes the music file and the game data interworked with each other.

The game apparatus 1 includes a download unit 25 for downloading a game package including the music file and the game data, a game controller 20 for controlling reproduction of the music file and the game data, a music storage unit 10 for storing the downloaded music, a game storage unit 15 for storing the downloaded game data, and a decoder 30 for decoding encoded music file and game data provided by the game server 100.

Generally, in the rhythm game, the game apparatus 1 should be provided with the music file and the game data matched to the music file together since the game data displayed in the game screen is designed according to the music. The music file and the game data may be provided to the game apparatus 1 as a single use item to be executed once or may be used many times or continuously according to a payment type.

The download unit 25 accesses the game server 100 through a network 200 to download the game package including the music file and the game data and the sound source list, which is a list of the music files. Further, the download unit 25 stores the music file of the downloaded game package and the sound source list in the music storage unit 10, and stores the game data in the game storage unit 15.

The music storage unit 10 stores the music file and the sound source list provided by the game server 100, and the music file stored in the music storage unit 10 maintains a state where the music file is stored in the music storage unit 10 even after the rhythm game is performed using the corresponding music.

The game storage unit 15 temporarily stores the game data provided by the game server 100, and the game date is deleted from the game storage unit 15 when the game is terminated.

Meanwhile, the game controller 20 according to the embodiment of the present invention controls whether the music file will be reproduced and the game data will be executed according to a determination from the game server 100.

When a user selects a music file displayed in a sound source list and purchases a game package, the game controller 20 controls the game program 40 such that the music file and the game data are executed only once. That is, when the user purchases the game package through the sound source list, the game controller 20 determines that the corresponding game package is for single use and limits the execution number of the music file and the game data included in the corresponding game package to one time.

When the user purchases the music file and the game data through a payment screen 800 of FIG. 8, which will be described later, the game controller 20 controls the game program 40 such that the music file and the game data are repeatedly executed. Purchasing costs of the music file and the game data purchased through the payment screen 800 are more expensive than those of the game package purchased through the sound source list. The purchasing costs are set to make the user repeatedly use the game package.

When the user purchases the same game package more than the preset certain number of times through the sound source list, the game controller 20 controls the game program 40 such that the corresponding music file and game data can be repeatedly reproduced.

Further, the game controller 20 provides the payment screen 800 for allowing the user to purchase music points used for purchasing the music file displayed in the sound source list through a prepayment system, and an amount of music points displayed in the sound source list is deducted from the total when the user selects to purchase the music file.

The game program 40 is installed in the game apparatus 1 to provide the game screen, synchronizes the game data provided by the game server 100 with the music file provided by the game server 100, displays the game data in the game screen according to a command from the game server 20, and executes the music file.

The game server 100 according to an embodiment of the present invention performs a payment according to a request from the game apparatus 1, and provides the game package stored in the game DB 150, the sound source list, and the game program 40 to the game apparatus 1 according to whether the payment has been performed. The game apparatus 1 requests to download the game package including the music file and the game data matched to the music selected by the user. At this time, the game server 100 transfers the game package to the game apparatus 1 only when the user pays the costs for the purchase of the game package.

When the user purchases the game package using the sound source list, the game server 100 provides the music file and the game data only once. However, when the user purchases the game package through the payment screen 800, which will be described later, if the rhythm game using the corresponding music file is executed, the game server 100 repeatedly provides the game package to the game apparatus 1. At this time, since the music file is already stored in the game apparatus 1, the game server 100 provides only the game data among the game package to the game apparatus 1.

The game DB 150 according to an embodiment of the present invention can store the music file, the sound source list, user information, and the game program 40 largely.

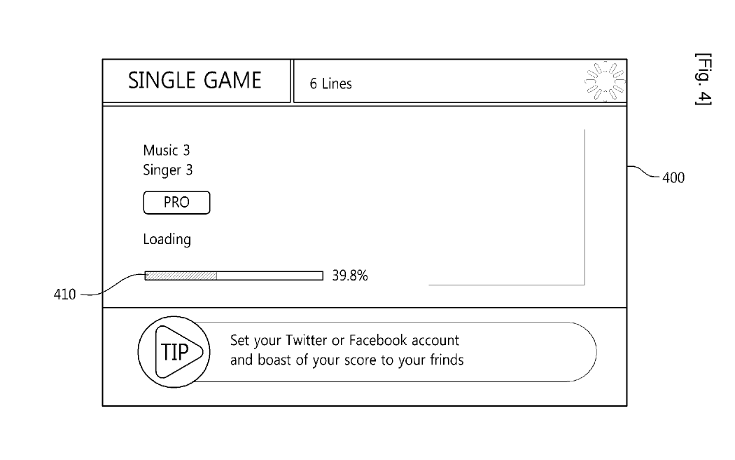

As shown in FIG. 3, the sound source list is a list arranging music files provided by the game DB 150 according to a preset order and indicates images of a singer and an album, a music file name, a singer name, an amount of points deducted in purchasing the music file, a difficulty level, a premium mark, a challenge mark, a fact of whether the user has purchased the music file, remaining music points 305 of the user, and a game point 310.

The premium mark is indicated in a music file, which the user can repeatedly use with only one purchase. When the user purchases a music file having the premium mark, the game controller 20 of the game apparatus 1 may control such that the music file having the premium mark and game data are downloaded and a corresponding game package is repeatedly executed.

The challenge mark is indicated in a part of music displayed in the sound source list. When the user successfully plays a rhythm game matched to a corresponding music file, the game controller 20 may allow the user to repeatedly use the corresponding music file and game data.

An arrangement order of music files included in the sound source list may be set in an alphabetical order, a best selling order, a price order, an updated order, etc.

At least one game data is generated for each music file, and generated such that notes displayed in the game screen are matched to a rhythm of music. The game data may be inexhaustibly designed while changing a type of the note (a note type), a shape, a color, a displayed pattern on the game screen, a movement pattern (a speed, a movement route, etc.) on the game screen of the note, etc.

User information contains information for a user authentication, such as a user ID, a password, personal information, and game related information, such as a music point purchase history, a premium package purchase history, a fact of whether a challenge is succeeded, or contents for a game point acquisition.

The decoder 30 decodes ciphers of an encoded music file and game data provided by the game server 100 to allow the decoded music file and game data to be executed in the game apparatus 1. The decoder 30 decodes ciphers of a music file and game data by using an AccountKey generated when making a user account in the game apparatus 1, a DeviceKey generated using an inherent ID of the game apparatus 1, a program InstallKey generated when installing the game program 40, and a SessionKey and a ServiceKey provided by the game server 100.

The game program 40 is software executing a game by synchronizing a music file and game data and then executing them. The game program 40 is provided to game apparatus 1 from the game server 100 and installed in the game apparatus 1. Each game program 40 has an inherent program InstallKey, and the program Installkey is automatically generated when the game program 40 is installed in the game apparatus 1.

The network 200 is a communication medium connecting the game apparatus 1 and the game server 100, and may include a mobile communication network or an internet. The game apparatus 1 can access the network 200 through a communication module, such as a wired or wireless LAN, or a mobile communication module.

So far, the rhythm game system according to an embodiment of the present invention has been schematically described. Hereinafter, the download unit 25, the music storage unit 10, game storage unit 15, the game controller 20, and the decoder 30 included in the game apparatus 1, and the game server 100 will be described in more detail.

In the game apparatus 1 according to an embodiment of the present invention, a user pays for purchase costs of a single use game package in every rhythm game execution and requests the game server 100 for a music file and game data to download them.

The download unit 25 of the game apparatus 1 accesses the game server 100 through the network 200 according to a command from the game controller 20 to request to download a music file and game data, and stores a music file and game data, which the game server 100 extracts from the game DB 150 and provides to the game apparatus 1, in the music storage unit 10 and the game storage unit 15, respectively.

Further, the download unit 25 downloads a sound source list from the game server 100. Contents of the sound source list may be changed according to whether the user has purchases/executes a game package, or a fact that the game server 100 adds/deletes a sound source file. Changed contents of the sound source list are updated in real time by the game server to be stored in the game DB 15, and the updated sound source list is provided to the game apparatus 1 through the download unit 25.

At this time, the game server 100 can provide the updated sound source list in real time, or can provide the updated sound source list to the game apparatus 1 through the download unit 25 in every preset regular time or at a preset certain time. The download unit 25 stores the sound source list provided by the game server 100 in the music storage unit 10.

The music storage unit 10 stores a music file and a sound source list provided by the game server 100. A music file stored once in the music storage unit 10 is not deleted from the music storage unit 10, but a game package cannot be executed unless game data matched to the music file is stored in the game storage unit 15. That is, when a music file is stored in the game apparatus 1, but game data is not downloaded from the game server 100, the music file cannot be used.

The game storage unit 15 temporarily stores game data provided by the game server 100, and the game data is deleted from the game storage unit 15 when a game is terminated.

At this time, cases where the game is terminated include a case where the user successfully plays the game so that the game is completed and a case where the user does not successfully play the game so that the game is terminated while the game is executed. In both the cases, the game data is deleted from the game storage unit 15 when the game is terminated. Accordingly, it is preferable that the game storage unit 15 uses a volatile memory, such as an SRAM (Static Random Access Memory), or a DRAM (Dynamic Random Access Memory).

As described above, although the music file and the game data are downloaded together, the music file maintains a state where the music file is stored in the music storage unit 10 and the game data is deleted.

The reason why the music file is stored in the music storage unit 10 is that a capacity of the music file is large so that a network traffic is increased and a download time is long if the music file is downloaded every time, which makes a loading time for playing the game long.

On the other hand, a capacity of the game data is small, so that a download time is short. As a result, the game data does not have to be stored in the game apparatus 1. In addition, since the user purchases the music file and the game data to use them as a single use item in the present invention, it is not required to store both the music file and the game data in the game apparatus 1.

Meanwhile, when both the music file and the game data are stored in the game apparatus 1, if the game apparatus 1 is maliciously hacked, the music file and the game data may be easily leaked since there is no restriction on a structure analysis of the music file or the game data, and an encryption key cannot help but be built into the game apparatus 1 even though the music file and the game data are encrypted to protect the music file and the game data from hacking. Further, a music file or game data may be used by loading the music file or the game data in the game apparatus 1 after obtaining the music file or the game data through another route by using a local storage loading function without directly hacking the music file and the game data. In this case, it is virtually impossible to discriminate between a legal user and an illegal user, so that it is impossible to apply sanctions against the illegal user.

However, in the present invention, the game data is deleted from the game apparatus 1 after the game is terminated, and the game data exists in an online state, so that a structure analysis of the game data is not easy. Further, since the user should pay purchase costs for the music file and the game data in every game execution, it is effective to prevent hacking in that the structure analysis is too costly. Furthermore, since only a legal user has a purchase history, only the legal user may be provided with a service. When a user obtains the music file and the game data through another route, the user cannot load them without hacking the game program 40 and the game data. In addition, since the music file and the game data are encrypted while encryption layers are overlapped and diversified through network encryption, encryption for each user, encryption for each session, encryption for each data, hacking is difficult. A process of encrypting the music file and the game data will be described later.

The game controller 20 controls an operation of the game program 40 according to whether the music file and the game data are provided by the game server 100, and actually controls a reproduction of the music file and an execution of the game data. At this time, the game controller 20 reproduces the music file and executes the game data according to a user command and whether the music file and the game data are allowed to be used.

Further, the game controller 20 may request the download of the music file and the game data together or the download of only the game data from the game server 100 according to whether the user has executed a game package including the corresponding music file by using the game apparatus 1 when the user selects the music file.

That is, when the user has executed the game package including the corresponding music file before, the game controller 20 requests only the game data matched to the corresponding music file from the game server 100 because the music file has been already downloaded. On the other hand, when the user has not executed the game package including the corresponding music file, the game controller 20 requests both the music file and the game data from the game server 100.

When the user purchases a game package including a single use music file by using the sound source list, the game controller 20 controls such that the music file is reproduced once and the game data is executed once according to a control of the game server 100. That is, although the user has downloaded and executed a game package including the music file already selected by the user so that the music file is stored in the music storage unit 10, if the game package is not purchased using a music point again, the game server 100 does not provide the game data. As a result, the game controller 20 may control such that a single use game package is executed only once.

When the user purchases a repetitive game package including a repetitive music file, the game controller 20 repeatedly allows a reproduction of the music file and an execution of the game data. At this time, since the music file is stored in the music storage unit 10, the game controller 20 may control such that a rhythm game is executed by downloading only the game data from the game server after a second execution. However, in a repetitive game package, a usage period of the game package may be set, and in this case, the game controller 20 controls such that the game package is repeatedly executed only in the usage period.

When the user purchases a single use game package displayed in the sound source list a preset number of times, the game controller 20 allows the corresponding game package to be repeatedly executed according to an instruction of the game server 100. For example, when the user purchases a game package including a music file of a particular song ten times, the game server 100 processes such that the user uses the corresponding game package free of charge after a subsequent execution. Accordingly, the game controller 20 executes a rhythm game by downloading only the game data from the game server 100 in every execution of the corresponding game package.

Meanwhile, the game server 100 according to the present invention extracts a music file and/or game data stored in the game DB 150 to provide them to the game apparatus 1 according to a request from the game controller 20 of the game apparatus 1. The game server 100 may provide both the music file and the game data to the game apparatus 1 or only the game data to the game apparatus 1 according to whether a game package including the corresponding music file has been executed before in the game apparatus 1. The game server 100 provides only the game data when the game package has been executed in the game apparatus 1, and the game server 100 provides the music file and the game data together when the game package has not been executed in the game apparatus 1.

It is also stored in the game DB 150 whether the game package including the corresponding music file has been used before in the game apparatus 1, so that the game server 100 can directly determine whether the game package has been used. Further, the game controller 20 of the game apparatus 1 requests or does not request the music file according to whether the game package including the corresponding music file has been used.

Meanwhile, the game server 100 determines whether information on the deduction of the music points in the game apparatus 1 is notified to the game server 100. When the music points are not deducted, the game server 100 does not provide the music file and/or the game data to the game apparatus 1.

However, when the game package including the selected music file has a premium mark and the user has already purchased the corresponding game package as a repetitive game package, the game server 100 extracts game data matched to the corresponding music file from the game DB 150 to transmit the extracted game data to the game apparatus 1 even though the music points are not deducted. When the user first downloads the repetitive game package after purchasing the corresponding repetitive game package, the game server 100 provides the music file and the game data to the game apparatus 1.

Further, when the user executes a game package including a music file having a challenge mark and successfully plays it, since the user can use the corresponding game package free of charge, the game server 100 extracts game data matched to the corresponding music file from the game DB 150 to transmit the extracted game data to the game apparatus 1.

It is stored in the game DB 150 whether the user has purchased the repetitive game package and the user has executed the game package having the challenge mark to successfully play it, so that the game server 100 can identify contents stored in the game DB 150 to determine it.

The game server 100 performs a payment of the music points according to a request of the game apparatus 1. That is, the game controller 20 provides a payment window and the user inputs information for the payment. When the corresponding information is transferred to the game server 100, the game server 100 is connected to an outside financial institution and performs the payment of the music points. The game server 100 stores a payment result in the game DB 150 and updates corresponding information in the game DB 150 every time when the music points are deducted in the game apparatus 1.

Meanwhile, the game server 100 encrypts a music file and game data provided to the game apparatus 1 with a plurality of encryption layers.

When a music file and game data are transmitted through a network, encryption between the game apparatus 1 and game server 100 use encryption keys of game apparatus 1 side and game server 100 side.

The encryption keys of game apparatus 1 side use a program installKey automatically generated in an installation of the game grogram 40 installed in the game apparatus 1, an AccountKey using a user account, and a DeviceKey using an inherent ID of the game apparatus 1. The game apparatus 1 logs in the game server 100 by using the program InstallKey, the AccountKey, and the DeviceKey to provide the corresponding keys to the game server 100.

The encryption keys of game server 100 side include a SessionKey and a ServiceKey. When a session is formed for the connection with the game apparatus 1, the game server 100 generates the SessionKey, which is a cipher for the session. The ServiceKey is a key by which a music file and game data are encrypted. The music file and the game data are encrypted by the ServiceKey to be stored in the game DB 150.

The game server 100 encrypts a music file and game data by using the program InstallKey provided by the game apparatus 1, the AccountKey, the DeviceKey, the SessionKey, and the ServiceKey, and provides the encrypted music file and game data to the game apparatus 1.

The aforementioned game server 100 may have the same construction as a web server or a web application server in an aspect of hardware. However, the game server 100 may include program modules which are implemented through various languages such as C, C++, Java, Visual Basic, Visual C to perform various functions in an aspect of software.

In general, the aforementioned game server 100 is connected to many and unspecified clients and/or other servers through an open computer network 200 such as an internet, and refers to a computer system which receives a task performing request of a client or another web server and draws a result of the task to provide the result, and computer software (a server program) installed for the computer system. However, it should be widely understood that the game server 100 includes a series of application programs operating on a web server or a web application server and various databases constructed in an inside as well as the aforementioned server programs according to occasions.

Further, the game server 100 may be implemented by using a server program variously provided to general hardware for a server according to operating systems such as DOS, Windows, Linux, UNIX, Macintosh, etc., and as representative server programs, a website used in a windows environment, and CERN, NCSAN, and APPACH used in an IS (Internet Information Server) and UNIX environment may be used.

Further, the game server 100 can classify member joining information, and various information and data related to contents to store them in a database and manage them. Such a database may be implemented in an inside or an outside of a server.

Each of processes of purchasing a single use game package and a repetitive game package according to the present invention is as follows.

When a game package is purchased through the sound source list, a music file and game data may be executed only once and the game package is referred to as a single use game package. As shown in FIG. 3, in the sound source list, a cost, which should be paid for one use, is indicated as a point type. When desired music is selected from the sound source list, the game controller 20 provides an identification window (not shown) displayed for identifying whether the game package will be purchased using the music point.

When the user accepts the identification, the game controller 20 determines whether an amount of music points of the user is enough to purchase the corresponding game package. When the amount of music points is enough, the game controller 20 deducts the amount of consumption points corresponding to purchase costs of the corresponding game package from the music point total.

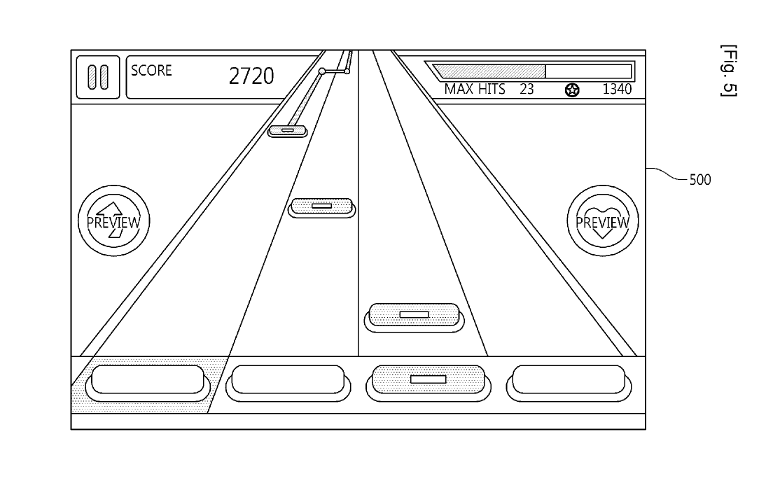

As shown in FIG. 4, the game controller 20 then provides a download window 400, and a selected music title, a game difficulty level, a download bar 410 indicating a process state of the download, and an image of a singer or an album are displayed in the download window 400.

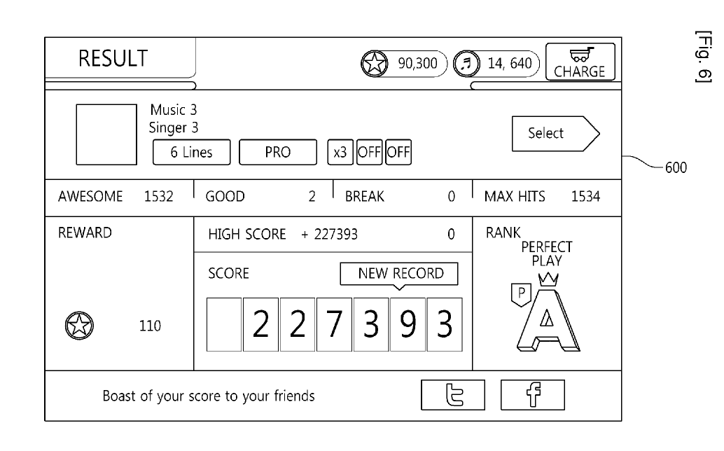

When the amount of music points is not enough, the game controller 20 displays a preview play screen 500 for 15 seconds free of charge as shown in FIG. 5. After using a preview play, the user can use a formal rhythm game by charging the music point.

Meanwhile, when the corresponding music file is first download, the game server 100 provides a game package including both the music file and game data to the game apparatus 1. On the other hand, when the corresponding music file has been downloaded before, a record indicating that the corresponding music file has been downloaded by the corresponding user remains in the game DB 150 so that the game server 100 provides only the game data.

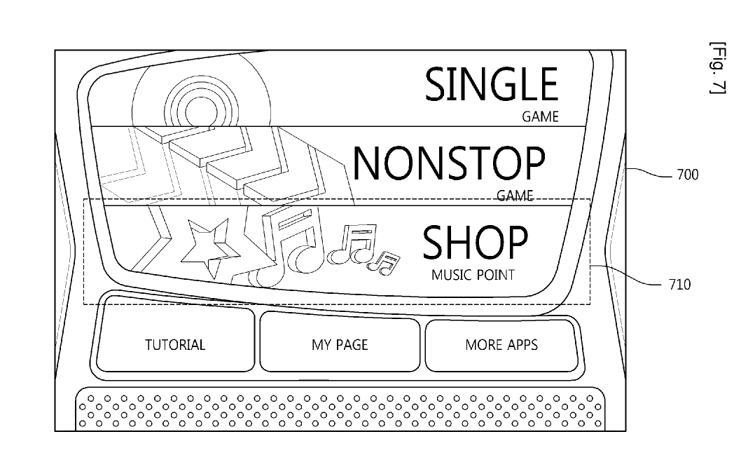

When the download is completed, the game controller 20 operates the game program 40 to control such that the music file and the game data are executed. At this time, a game screen having the same structure as the preview play screen 500 of FIG. 5 is displayed in the game apparatus 1. When the user plays the game and then the game is terminated, the game controller 20 displays a result screen 600 indicating a game result as shown in FIG. 6. The remaining music points together with the highest score obtained by performing the rhythm game through the music file and the game data by gamers and a user score are displayed in the result screen 600.

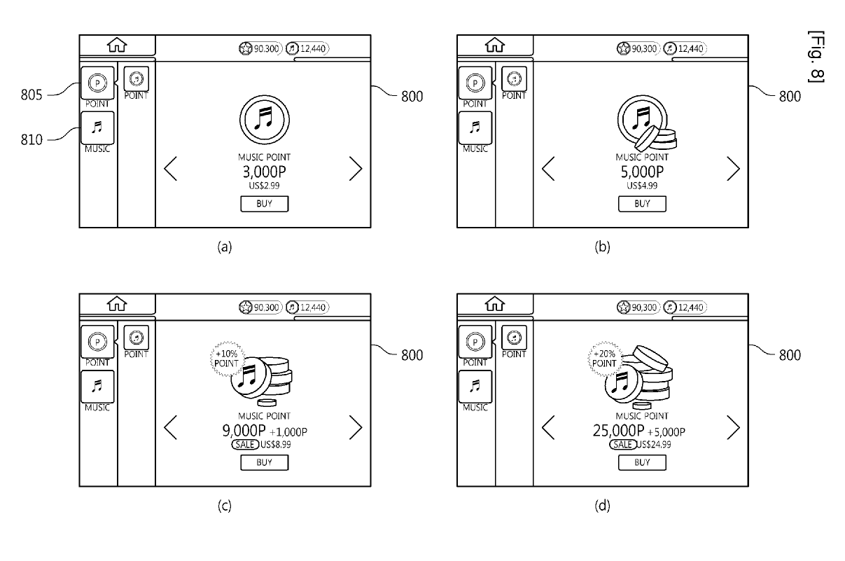

A repetitive game package is a game package including a music file having a premium mark included in the sound source list. When the user selects a shop menu 710 in a main menu screen 700 displayed in the game apparatus 1 shown in FIG. 7 and selects a music button 810 in a payment screen 800 of FIG. 8, the repetitive game package may be purchased. At this time, a music title of the music file, a game difficulty level, a download state indication bar, and an image of a singer or an album are displayed in the list.

When the repetitive game package is purchased, the game controller 20 transfers a purchase history to the game server 100 and the game server 100 constructs a sound source list having an updated purchase history to provide the sound source list to the game apparatus 1. Then, a separate indication informing the purchase of the music file included in the purchased repetitive game package is generated in the sound source list displayed in the game apparatus 1.

The game controller 20 provides the payment screen 800 through which the points, which are used for purchasing the music file displayed in the sound source list, are purchased in advance. When the user selects to purchase the music file, an amount points displayed in the sound source list is deducted from the total. FIGS. 8A to 8D illustrate the payment screen 800 provided by the game controller 20.

A point button 805 for the purchase of the music points and a music button 810 for the purchase of the repetitive game package are included in the payment screen 800. When the point button 805 is selected, a quantity of the purchasable music points and a purchase button are formed. At this time, the quantity of the purchasable music points may be variously set. When any of arrow buttons displayed in both sides of the music point is pressed, the user can select the music point quantity of 3000 P, 5000 P, 9000 P, or 25000 P to purchase the music points in this embodiment. When the purchase button formed under the music point quantity, a payment window (not shown) for inputting a name and a card number of the user for the purchase is displayed.

The music button 810 formed in the payment screen 800 is used to purchase the game package including the game data and the repetitive music file capable of being repeatedly reproduced. When the user selects the music button 810, a purchasable repetitive music file is displayed in a form of a list. When the user selects the music file, the payment window for inputting a name and a card number for the purchase is displayed. Purchase costs of the repetitive music file are set to be more expensive than costs of using the music file displayed in the sound source list once.

Meanwhile, game points accumulated by playing the rhythm game by a user are displayed in an upper part of the payment screen 800, and a user who uses all the purchased music points can purchase a music file by using the game points.

A payment type for the purchase of the game package is transferred to the game server 100 through the download unit 25, and the game server 100 stores the payment type in the game DB 150.

The aforementioned rhythm game apparatus 1 according to an embodiment may be an arcade game machine, which may be used in a game room, and may be a portable game machine such as a Play Station Portable (PSP), a PDA (Personal Digital Assistant), a PMP (Portable Media Player), a smart phone, a tablet PC, and a mobile communication terminal, or a computer such as a desktop or a notebook.

When the rhythm game apparatus 1 is a smart phone, a tablet PC, a PDA, or a mobile communication terminal, the rhythm game apparatus 1 may have an operating system for mobile such as an Android of Google, an iOS (iPhone OS) of Apple, or a mobile windows of Microsoft. The game server 100 may have compatibility with an operating system for mobile in order to communicate with a terminal having the operating system for mobile.

The smart phone, the tablet PC, the PDA, and the mobile communication terminal can access the network 200 through a communication module such as a wired or wireless LAN (WiFi) or a mobile communication module.

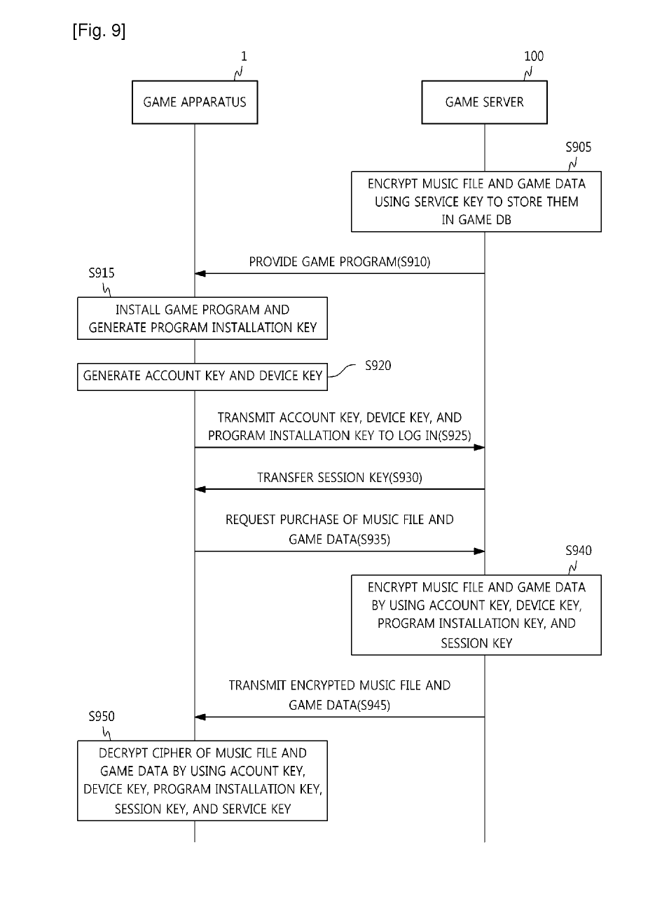

When the game server 100 according to the embodiment of the present invention provides a music file and game data to the game apparatus 1, the music file and the game data are overlapped with a plurality of encryption layers and encrypted. Referring to FIG. 9, the encryption process is as follows.

The music file and the game data are initially encrypted with the ServiceKey and stored in the game DB 150. In order to execute a game in the game apparatus 1, the game program 40 is required and the game server 100 provides the game program 40 to the game apparatus 1 S910. When the game program 40 is installed in the game apparatus 1, the inherent program InstallKey is automatically generated as described above S915. Accordingly, the inherent program InstallKey of the corresponding game program 40 is stored in the game apparatus 1.

Meanwhile, the AccountKey using a user account used for accessing the game server 100, and the DeviceKey using an ID of the game apparatus 1 which the user has are generated in the game apparatus S920. When the user logs in to the game server 100, the AccountKey and the DeviceKey with the program InstallKey are transferred to the game server 100 through an encrypted network protocol so that the game apparatus 1 logs in to the game server 100 S925.

When the session between the game apparatus 1 and the game server 100 is formed all the time, the game server 100 generates the SessionKey, which is an inherent key for the session, to transfer the SessionKey to the game apparatus 1 S930. Every time the game apparatus 1 accesses the game server 1, the game server 100 determines a SessionKey by using a random number generation algorithm and transfers the determined SessionKey to the game apparatus 1 to update the transferred SessionKey.

When the game apparatus 1 requests the purchase of a music file and game data from the game server 100 S935, the game server 100 encrypts the music file and the game data by using the AccountKey, the DeviceKey, the InstallKey, and the SessionKey to transfer the encrypted music file and game data to the game apparatus 1 S940 and S945.

The game apparatus 1 decrypts a cipher by using the AccountKey, the DeviceKey, the InstallKey, the SessionKey, and the ServiceKey to store the music file and the game data in the music storage unit 10 and the game storage unit 15, respectively S950.

Accordingly, the music file and the game data are encrypted to be overlapped across a plurality of encryption layers, so that the risk of hacking may be markedly reduced.

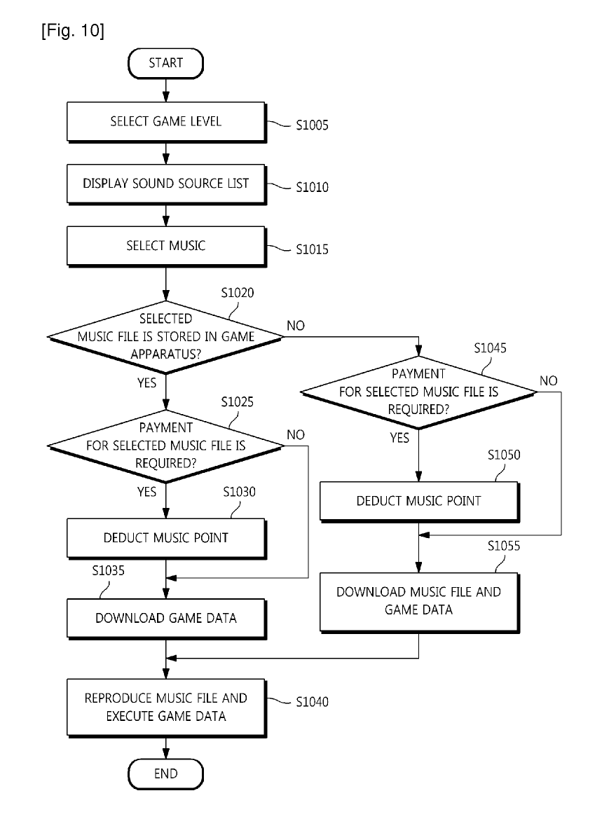

Hereinafter, a process of purchasing a single use game package including a music file and game data in the game apparatus 1 according to the present invention will be described with reference to FIG. 10.

When the user selects a game level through a game screen S1005, the sound source list divided according to the game level, which is similar as that of FIG. 3, is displayed in a display of the game apparatus 1 S1010. Here, the game package purchased through the sound source list is a single use game package. When music is selected from the sound source list S1015, the game controller 20 determines whether the selected music file is stored in the music storage unit 10 S1020.

As a result of the determination in step S1020, when the music file is stored in the music storage unit 10, the game controller 20 determines whether a payment is required for the purchase of a game package including the selected music file S1025.

Here, the reason why the determination for the payment is required is that it is not necessary to deduct the music points for the following cases where the user has already purchased a game package including a music file having a premium mark through the payment window 800, the user successfully plays a rhythm game including a music file having a challenge mark so the user can use it free of charge, or the user selects music, which is provided free of charge, among music displayed in the sound source list.

As a result of the determination in step S1025, when the payment is required, the game controller 20 deducts purchase costs for the game package including the corresponding music file from the user's music points S1030. A result of the deduction of the music points is displayed in the result screen 600 displayed when the user terminates a game as shown in FIG. 6.

At the same time, the game controller 20 requests the download of a game package including game data matched to the corresponding music file from the game server 100. The game server 100 extracts the game data matched to the corresponding music file from the game DB 150 to transfer the extracted game data to the game apparatus 1 S1035.

The download unit 25 of the game apparatus 1 temporarily stores the game data in the game storage unit 15. The game controller 20 extracts the music file from the music storage unit 10, and the game data from the game storage unit 15 to provide the extracted music file and game data to the game program 40. The game program 40 synchronizes the music file and the game data, and then executes the synchronized music file and game data S1040.

Meanwhile, when the payment is not required in step S1025, the game controller 20 requests the download of a game package including game data matched to the corresponding music file from the game server 100. The game server 100 extracts the game data matched to the corresponding music file from the game DB 150 to transmit the extracted game data to the game apparatus 1 S1035. Then, it proceeds to step S1040 and the game controller 20 extracts the music file from the music storage unit 10, and the game data from the game storage unit 15 to provide the extracted music file and game data to the game program 40. The game program 40 synchronizes the music file and the game data, and then executes the synchronized music file and game data.

Meanwhile, as a result of the determination in step S1020, when the selected music file is not stored in the game apparatus 1, the game controller 20 determines whether the payment for the purchase of a game package including the selected music file is required S1045.

As a result of the determination in step S1045, when the payment is required, the game controller 20 deducts purchase costs of a game package including the corresponding music file from the user's music points S1050. Then, the game controller 20 requests the download of a game package including both the corresponding music file and game data from the game server 100. The game server 100 extracts the corresponding music file and game data from the game DB 150 to transmit the extracted music file and game data to the game apparatus 1 S1055.

The download unit 25 of the game apparatus 1 temporarily stores the music file in the music storage unit 10 and the game data in the game storage unit 15. Then, the game controller 20 extracts the music file from the music storage unit 10 and the game data from the game storage unit 15 to provide the extracted music file and game data to the game program 40. The game program 40 synchronizes the music file and the game data, and then executes the synchronized music file and game data S1040.

Meanwhile, as a result of the determination in step S1045, when the payment is not required, the game controller 20 requests the download of a game package including the corresponding music file and game data from the game server 100. The game server 100 extracts the corresponding music file and game data from the game DB 150 to transmit the extracted music file and game data to the game apparatus 1 S1055.

Subsequently, it proceeds to step S1040 and the game controller 20 extracts the music file from the music storage unit 10 and the game data from the game storage unit 15 to provide the extracted music file and game data to the game program 40. The game program 40 synchronizes the music file and the game data, and then executes the synchronized music file and game data.

When the game is terminated, the game controller 20 deletes the game data stored in the game storage unit 15.

Meanwhile, when the user desires to purchase a repetitive game package, which can be repeatedly used, the user selects a shop menu 710 in a main menu screen 700 as shown in FIG. 7. When a payment screen 800 as shown in FIG. 8 is displayed by the shop menu selection, the user selects a point button 805 in the corresponding screen. Then, the user selects the purchasable music points displayed in the payment screen 800 by using an arrow, and selects a purchase button under the music points. Then, the game controller 20 provides a payment window.

When information required for the payment is transferred to the game server 100 through the payment window, the game server 100 performs the payment. When the payment is completed, the game server 100 stores a payment type in the game DB 150.

As described above, the game apparatus 1 allows the music file and the game data to be purchased once so that costs of the game data including the music file may be markedly reduced in comparison with costs, which should be paid for a sound source itself, in purchasing a conventional music file. Accordingly, the user can enjoy the rhythm game once without any burden, and it can be prevented to purchase a music file which is not used. Further, the user can separately purchase a game package including a music file, which the user desires to repeatedly use, which promotes to cause the user satisfaction.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

### CROSS-REFERENCE TO RELATED APPLICATION

This application claims priority from and the benefit under 35 U.S.C. §119(a) of Korean Patent Application No. 10-2011-0072147, filed on Jul. 20, 2011, which is hereby incorporated by reference for all purposes as if fully set forth herein.

1. A game apparatus comprising:
a download unit for, when a music file is selected from a sound source list including one or more music files in performing a rhythm game, in which game data displayed in a game screen is changed according to the music file, accessing an outside game server to download a game package including the music file and the game data matched to the music file; and
a game controller for controlling a reproduction number of the music file and the game data downloaded from the game server according to a purchase payment type of the game package.

2. The game apparatus as claimed in claim 1, wherein, when the game package is purchased by selecting a music file from the sound source list, the download unit downloads the game package including both the music file and the game data matched to the music file, and the game controller controls such that the music file and the game data included in the game package are reproduced only once.

3. The game apparatus as claimed in claim 1, wherein, when a game package including identical music file and game data is purchased in the sound source list a preset number of times, the game controller controls such that the music file and the game data can be repeatedly reproduced.

4. The game apparatus as claimed in claim 1, wherein the sound source list includes music having an indication of a premium mark, and the game controller allows a game package to be repeatedly used when the game package including the music file having the indication of the premium mark and game data is purchased.

5. The game apparatus as claimed in claim 1, wherein the sound source list includes music having an indication of a challenge mark, and the game controller allows a game package to be repeatedly used when the game package including the music file having the indication of the challenge mark and game data is purchased and a corresponding rhythm game has been successfully played.

6. The game apparatus as claimed in claim 1, further comprising a music storage unit for storing the music file, wherein the game controller stores a downloaded music file in the music storage unit and extracts the music file stored in the music storage unit to reproduce the extracted music file when game data matched to the music file is downloaded.

7. The game apparatus as claimed in claim 1, further comprising a game storage unit for storing the game data, wherein the game controller temporarily stores downloaded game data in the game storage unit and deletes the game data when the rhythm game is terminated.

8. The game apparatus as claimed in claim 1, wherein the game controller provides a payment screen, through which a music point used for purchasing a music file displayed in the sound source list is purchased in advance, and a purchase cost corresponding to a preset cost is deducted from the music point when a game package including the music file and game data is purchased.

9. The game apparatus as claimed in claim 1, wherein, when the game package is purchased, the game controller deducts a purchase cost corresponding to a preset cost from a game point accumulated by an execution of the rhythm game.

10. A game system comprising:
a game DB for storing a game package, to which one or more music files used for a rhythm game, in which game data displayed in a game screen is changed according to the music file, and the game data, which is designed according to each of the music files, are matched;
game apparatus for downloading the game package stored in the game DB and executing the music file and the game data interworked with each other; and
a game server for controlling a reproduction number of the music file and the game data according to a purchase payment type of the game package.

11. The game system as claimed in claim 10, wherein a sound source list, in which the music files are divided and indicated, is stored in the game DB, and the game server updates the sound source list according a purchase history of the game package in the game apparatus to provide the updated sound source list to the game apparatus.

12. The game system as claimed in claim 11, wherein, when a music file is selected and purchased in the sound source list, the game server limits a reproduction number of the music file and the game data to only one.

13. The game system as claimed in claim 10, wherein the game server encrypts a music file and game data, which is stored in the game DB, encrypted with a service key by using at least one of an account key using a user account provided by the game apparatus, a device key, which is an ID of the game apparatus, a program installation key installed in the game apparatus, and a session key provided to a session between the game server and the game apparatus, and provides the encrypted music file and game data to the game apparatus, and wherein the game apparatus further comprising a decoder for decrypting encrypted music file and game data provided by the game server by using at least one of the account key, the device key, the program installation key, the session key, and the service key.

14. A game method comprising:
displaying a sound source list including one or more music files required for performing a rhythm game, in which game data displayed in a game screen is changed according to the music file;
downloading, when a particular music file is selected from the music files in the sound source list, a game package including the music file together with the game data matched to the music file;
executing the music file and the game data interworked with each other; and
determining whether the music file and the game data will be executed again according to a purchase payment type of the music file and the game data.

15. The method as claimed in claim 14, further comprising, when music is selected from the sound source list, paying a cost for using the game package including the music file and the game data once.

16. A computer readable recording medium recording a program for implementing a game method, the program implementing functions of:
downloading, when a music file is selected from a sound source list including one or more music files in performing a rhythm game, in which game data displayed in a game screen is changed according to the music file, a game package including the music file and the game data matched to the music file from an outside game server;
reproducing the music file and the game data interworked with each other; and
limiting a reproduction number of the music file and the game data according to a purchase payment type of the game package.
